(19) United States
(12) Patent Application Publication
(10) Pub. No.: US 2019/0179999 A1
(43) Pub. Date: Jun. 13, 2019

(54) METHOD AND DEVICE FOR SEARCHING BINDING SITE OF TARGET MOLECULE

(71) Applicant: FUJITSU LIMITED, Kawasaki-shi (JP)

(72) Inventor: Hiroyuki SATO, Yokohama (JP)

(73) Assignee: FUJITSU LIMITED, Kawasaki-shi (JP)

(21) Appl. No.: 16/178,126

(22) Filed: Nov. 1, 2018

(30) Foreign Application Priority Data
Dec. 12, 2017 (JP) 2017-237447

(51) Int. Cl. G06F 19/12

(52) U.S. Cl. CPC G06F 19/12

(57) ABSTRACT

Method causing computer to execute steps including: performing molecular dynamic calculation in the presence of water molecules using target molecule and probe molecules around the target in coordinate space with unnatural repulsive force being added between the probes; selecting probe molecule stably bound with the target among the probes using result of the molecular dynamic calculation; performing molecular dynamic calculation in the presence of water molecules using the target, the selected probe, and other probe molecules with no unnatural repulsive force being added between the selected probe and other probes [second calculation step]; selecting probe stably bound with the target among other probes using result of the molecular dynamic calculation [second selection step]; and determining binding site of the target using the probes selected through selection steps performed two or more times after performing the second calculation step and second selection step once or two or more times.

### CROSS-REFERENCE TO RELATED APPLICATION

This application is based upon and claims the benefit of priority of the prior Japanese Patent Application No. 2017-237447, filed on Dec. 12, 2017, the entire contents of which are incorporated herein by reference.

### FIELD

The embodiments discussed herein are related to a method and device for searching a binding site of a target molecule.

### BACKGROUND

When a target molecule, such as certain protein, has a functional site that adversely affects human bodies, it is important to design a ligand that stably binds with the functional site of the target molecule in the course of drug discovery for the target molecule serving as a target. The functional site of the target molecule is blocked by stabling binding the ligand with the target molecule. As a result, the adverse effect of the target molecule to human bodies can be prevented.

When a site of a target molecule with which a ligand is bound (may be referred to as a “binding site” hereinafter) is searched, reported is a technique for performing molecular dynamics (MD) calculations including a target molecule and a large amount of ligands or probe molecules in order to enhance binding efficiency between the target molecule and the ligands or probe molecules that are fragments of the ligands (see, for example, Japanese Patent Application Laid-Open (JP-A) No. 2006-209764). However, the ligand or probe molecule may be separated from the target molecule because a large amount of the ligands or probe molecules cause aggregations and therefore a target bond may not be obtained.

As a method for preventing aggregation between ligands or between probe molecules, therefore, proposed is a technique for adding repulsive potential between ligands or between probe molecules (see, for example, J. Chem. Inf. Model., (2011) 51, 877). When a target molecule has a wide pocket into which a plurality of ligands or probe molecules can be bound, however, targeted ligand binding or probe binding may not be obtained because of repellence between the ligands or repellence between the probe molecules.

### SUMMARY

According to one aspect of the present disclosure, a method for searching a binding site of a target molecule is a method causing a computer to execute steps including a first calculation step, a first selection step, a second calculation step, a second selection step, and a determination step. The first calculation step includes performing a molecular dynamic calculation in the presence of water molecules, where the molecular dynamic calculation is performed using a target molecule and a plurality of probe molecules arranged around the target molecule in a coordinate space, in the state that unnatural repulsive force is added between the probe molecules. The first selection step includes selecting the probe molecule stably bound with the target molecule among the probe molecules using a result of the molecular dynamic calculation of the first calculation step. The second calculation step includes performing a molecular dynamic calculation in the presence of water molecules, where the molecular dynamic calculation is performed using the target molecule, the selected probe molecule, and the other probe molecules, in the state that no unnatural repulsive force is added between the selected probe molecule and the other probe molecules. The second selection step includes selecting the probe molecule stably bound with the target molecule among the other probe molecules using a result of the molecular dynamic calculation of the second calculation step. The determination step includes determining a binding site of the target molecule using selected probe molecules through the selection steps performed two or more times after performing the second calculation step and the second selection step once or two or more times.

According to one aspect of the present disclosure, a device for searching a binding site of a target molecule includes a first calculation unit configured to execute a first calculation step, a first selection unit configured to execute a first selection step, a second calculation unit configured to execute a second calculation step, a second selection unit configured to execute a second selection step, and a determination unit configured to execute a determination step. The first calculation step includes performing a molecular dynamic calculation in the presence of water molecules, where the molecular dynamic calculation is performed using a target molecule and a plurality of probe molecules arranged around the target molecule in a coordinate space, in the state that unnatural repulsive force is added between the probe molecules. The first selection step includes selecting the probe molecule stably bound with the target molecule among the probe molecules using a result of the molecular dynamic calculation of the first calculation step. The second calculation step includes performing a molecular dynamic calculation in the presence of water molecules, where the molecular dynamic calculation is performed using the target molecule, the selected probe molecule, and the other probe molecules, in the state that no unnatural repulsive force is added between the selected probe molecule and the other probe molecules. The second selection step includes selecting the probe molecule stably bound with the target molecule among the other probe molecules using a result of the molecular dynamic calculation of the second calculation step. The determination step includes determining a binding site of the target molecule using selected probe molecules through the selection steps performed two or more times after performing the second calculation step and the second selection step once or two or more times.

According to one aspect of the present disclosure, a program for causing a computer to execute a disclosed method for searching a binding site of a target molecule coordinate space. The method includes a first calculation step, a first selection step, a second calculation step, a second selection step, and a determination step. The first calculation step includes performing a molecular dynamic calculation in the presence of water molecules, where the molecular dynamic calculation is performed using a target molecule and a plurality of probe molecules arranged around the target molecule in a coordinate space, in the state that unnatural repulsive force is added between the probe molecules. The first selection step includes selecting the probe molecule stably bound with the target molecule among the probe molecules using a result of the molecular dynamic calculation of the first calculation step. The second calculation step includes performing a molecular dynamic calculation in the presence of water molecules, where the molecular dynamic calculation is performed using the target molecule, the selected probe molecule, and other probe molecules, in the state that no unnatural repulsive force is added between the selected probe molecule and the other probe molecules. The second selection step includes selecting the probe molecule stably bound with the target molecule among the above-mentioned other probe molecules using a result of the molecular dynamic calculation of the second calculation step. The determination step includes determining a binding site of the target molecule using the probe molecules selected through the selection steps performed two or more times after performing the second calculation step and the second selection step once or two or more times.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a view illustrating one example of an index when the presence or absence of stable binding is judged (part 1);

FIG. 1B is a view illustrating one example of an index when the presence or absence of stable binding is judged (part 2);

FIG. 2A is a view illustrating one example of an index when the presence or absence of stable binding is judged (part 3);

FIG. 2B is a view illustrating one example of an index when the presence or absence of stable binding is judged (part 4);

FIG. 3 is a flowchart describing one example of the disclosed method for searching a binding site of a target molecule;

FIG. 4 is a flowchart describing another example of the disclosed method for searching a binding site of a target molecule;

FIG. 5 is a flowchart describing another example of the disclosed method for searching a binding site of a target molecule;

FIG. 6 is a diagram illustrating a structural example of the disclosed device for searching a binding site of a target molecule;

FIG. 7 is a diagram illustrating another structural example of the disclosed device for searching a binding site of a target molecule;

FIG. 8 is a diagram illustrating another structural example of the disclosed device for searching binding site of a target molecule; and

FIG. 9 is a model view illustrating a binding site searched by Example 1 and two probe molecules.

### DESCRIPTION OF EMBODIMENTS

Drug discovery refers to a process for designing pharmaceutical products. For example, the drug discovery is performed in the following order.
(1) Determination of a target molecule
(2) Searching a lead compound etc.
(3) Examination of physiological effects
(4) Safety/toxicity test

It is important in the search of a lead compound etc. (a lead compound and a compound derived from the lead compound) that interaction between each of numerous drug candidate molecules and a target molecule is highly accurately evaluated.

A process for designing pharmaceutical product using a computer may be referred to as IT drug discovery. The technology of the IT drug discovery can be used for drug discovery in general. Among them, use of the IT drug discovery in a search of a lead compound etc. is effective for reducing a time period for and increasing a probability of developing a new drug.

For example, the disclosed technology can be used for a search of a lead compound etc. that is expected to have high pharmacological activity.

The disclosed embodiments aim to provide a method and device for searching a binding site of a target molecule where the method and device can search a binding site with which a plurality of probe molecules can be bound, and to provide a program for executing the method.

The disclosed method for searching a binding site of a target molecule can solve the above-mentioned various problems existing in the art, can achieve the above-mentioned object, and can provide a method for searching a binding site of a target molecule where the method can search a binding site with which a plurality of probe molecules can be bound.

The disclosed device for searching a binding site of a target molecule can solve the above-mentioned various problems existing in the art, can achieve the above-mentioned object, and can provide a device for searching a binding site of a target molecule where the device can search a binding site with which a plurality of probe molecules can be bound.

The disclosed program for searching a binding site of a target molecule can solve the above-mentioned various problems existing in the art, can achieve the above-mentioned object, and can provide a method for searching a binding site of a target molecule where the program can search a binding site with which a plurality of probe molecules can be bound.

### (Method for Searching Binding Site of Target Molecule)

The disclosed method for searching a binding site of a target molecule is a search method of a binding site of a target molecule where the search method is to search a binding site of a target molecule using a computer.

The method for searching a binding site of a target molecule includes at least a first calculation step, a first selection step, a second calculation step, a second selection step, and a determination step, and may further include other steps according to the necessity.

The method for searching a binding site of a target molecule is executed by a computer. The number of computers used for the method for searching a binding site of a target molecule may be 1, or 2 or more. For example, the method for searching a binding site of the target molecule may be performed dividedly by a plurality of computers.

In order to prevent aggregations that may be caused between a plurality of probe molecules when a binding site of a target molecule is searched using a molecular dynamic calculation, repulsive force may be added between the probe molecules. In this case, however, the probe molecules are repelled from one another also within a binding site. As a result, only one probe molecule can present within a binding site, and a binding site capable of binding a plurality of probe molecules cannot be searched.

Therefore, the present inventor diligently conducted researches. As a result, the present inventor has reached the following insights. When a molecular dynamic calculation is performed using a target molecule and a plurality of probe molecules in the state that repulsive force is added between the plurality of probe molecules, repulsive force is not added between probe molecules that are considered to be within a binding site of the target molecule and other probe molecules at the time a sequential molecular dynamic calculation is performed. As a result, aggregations of probe molecules can be prevented outside the binding site, and a plurality of probe molecules can be present within the binding site, and therefore a binding site with which a plurality of probe molecules can be bound can be searched. Based on the above-mentioned insights, the disclosed invention has been accomplished.

### <First Calculation Step>

The first calculation step is a step including performing a molecular dynamic calculation in the presence of water molecules, where the molecular dynamic calculation is performed using a target molecule and a plurality of probe molecules arranged around the target molecule in a coordinate space, in the state that unnatural repulsive force is added between the plurality of probe molecules.

A method for arranging the target molecule, the probe molecules, and the water molecules in the coordinate space is not particularly limited and may be appropriately selected depending on the intended purpose. Examples of the method include a method where a configuration of a target molecule, configurations of probe molecules, and configurations of water molecules are built in a three-dimensional coordinate space using configuration data of the target molecule, configuration data of the probe molecules, and configuration data of the water molecules.

For example, the configuration data includes atom information data, coordinate information data, and bond information data.

A format of the data mentioned above is not particularly limited and may be appropriately selected depending on the intended purpose. For example, the format may be text data, a structure data file (SDF) format, or a MOL file format.

A method for building a configuration of a target molecule, configurations of probe molecules, and configurations of water molecules in a three-dimensional coordinate space is not particularly limited and may be appropriately selected depending on the intended purpose. Examples of the method include the following methods.

First, a configuration of a target molecule is built in a three-dimensional coordinate space using configuration data of the target molecule. Subsequently, configurations of probe molecules are built in the same three-dimensional coordinate space using configuration data of the probe molecules. Finally, configurations of water molecules are built in the same three-dimensional coordinate space using configuration data of the water molecules. In order to reproduce an actual space, the configurations of the probe molecules, the configuration of the target molecule, and the configurations of the water molecules are generally arranged not to overlap with one another.

Building of the configurations of the probe molecules may be performed by building a configuration of one probe molecule at a time, or building configurations of probe molecules at once.

Building of the configurations of the water molecules may be performed by building a configuration of one water molecule at a time, or building configurations of water molecules at once.

The target molecule is not particularly limited and may be appropriately selected depending on the intended purpose. Examples of the target molecule include protein, ribonucleic acid (RNA), and deoxyribonucleic acid (DNA).

The probe molecule is a small molecule used for searching a binding site and can be a fragment of a drag candidate molecule.

A plurality of probe molecules used in the first calculation step may be one kind of probe molecules or two or more kinds of probe molecules.

The number of probe molecules arranged in a tree-dimensional coordinate space is not particularly limited and may be appropriately selected in view of, for example, a size and type of the target molecule and a concentration of the probe molecules around the target molecule when the probe molecules are arranged.

The number of the water molecules arranged in the three-dimensional coordinate space is not particularly limited and may be appropriately selected depending on, for example, a size and type of the target molecule, and a concentration of the probe molecules and a concentration of the water molecules in the surrounding area of the target molecule when the water molecules are arranged.

When the molecular dynamic calculation is performed, heavy atoms of the target molecule may be restrained or not restrained, but the heavy atoms thereof are preferably restrained. The heavy atoms mean atoms other than hydrogen atoms.

The restraining of the heaving atoms can prevent more than necessary movement or deformation of the target molecule.

A method for the restraining is not particularly limited and may be appropriately selected depending on the intended purpose. Examples of the method thereof include restriction with a spring.

The molecular dynamic calculation can be performed using a molecular dynamic calculation program. Examples of the molecular dynamic calculation program include AMBER, CHARMm, GROMACS, GROMOS, NAMD, and myPresto.

The duration of the molecular dynamic calculation is not particularly limited and may be appropriately selected depending on the intended purpose.

In the molecular dynamic calculation, interactions allowed to act between probe molecules in a typical molecular dynamic calculation are considered. Examples of the interactions include hydrogen binding, Van der Waals interaction, and hydrophobic interaction.

In the molecular dynamic calculation, moreover, unnatural repulsive force is applied between the probe molecules. The unnatural repulsive force means repulsive force other than interactions typically and actually generated between probe molecules.

The unnatural repulsive force is preferably repulsive force that increases as a distance between probe molecules decreases in view of prevention of aggregation between the probe molecules. Examples of the repulsive force include repulsive force that increases exponentially as a distance between probe molecules decreases.

### <First Selection Step>

The first selection step is a step including selecting the probe molecule stably bound with the target molecule (may be referred to as a “first selection probe molecule” hereinafter) among the probe molecules using the result of the molecular dynamic calculation of the first calculation step.

The probe molecule stably bound with the target molecule means, in other words, the probe molecule having strong interaction with the target molecule. Such a probe molecule is highly likely present within a binding site of the target molecule.

In the first selection step, the presence or absence of the stable binding is preferably determined based on a distance from a sphere set based on the target molecule, a distance from a surface of the target molecule, and fluctuations of the probe molecule.

Examples of the sphere include a sphere encapsulating the target molecule. A size of the sphere is not particularly limited and may be appropriately selected depending on the intended purpose.

For example, it is preferred that a probe molecule be judged as to be stably bound with the target molecule when all of the following (1) to (3) are satisfied.
(1) A probe molecule is present inside a sphere set based on the target molecule.
(2) The probe molecule is present within a certain distance from a surface of the target molecule.
(3) Fluctuations of the probe molecule are within the predetermined range.

Note that, (1) to (3) are judged, for example, by snapshots in a molecular dynamic calculation. At the time of the judgement, a relative position of the probe molecule to the target molecule may be determined from the average coordinate of all of the snapshots. Among all of the snapshots, moreover, a relative position of the probe molecule where the probe molecule is present on coordinates that are farthest from the target molecule may be regarded as a relative position of the probe molecule to the target molecule.

There is a case where the above-mentioned (1) is satisfied but the above-mentioned (2) is not satisfied. In the case where a configuration of the target molecule is close to a rectangle, for example, a probe molecule may be present within a sphere set based on the target molecule but is far from a surface of the target molecule. In such a case, it is considered that the probe molecule has weak interaction with the target molecule and it cannot be said that the probe molecule is stably bound with the target molecule.

Moreover, there is a case where the above-mentioned (1) and the above-mentioned (2) are satisfied but the above-mentioned (3) is not satisfied. In such a case, a probe molecule is close to the target molecule but motions of the probe molecule are not restrained with the target molecule. Therefore, it is considered that the probe molecule has weak interaction with the target molecule and it cannot be said that the probe molecule is stably bound with the target molecule.

Therefore, it is preferred that a probe molecule be judged to be stably bound with the target molecule when all of (1) to (3) are satisfied.

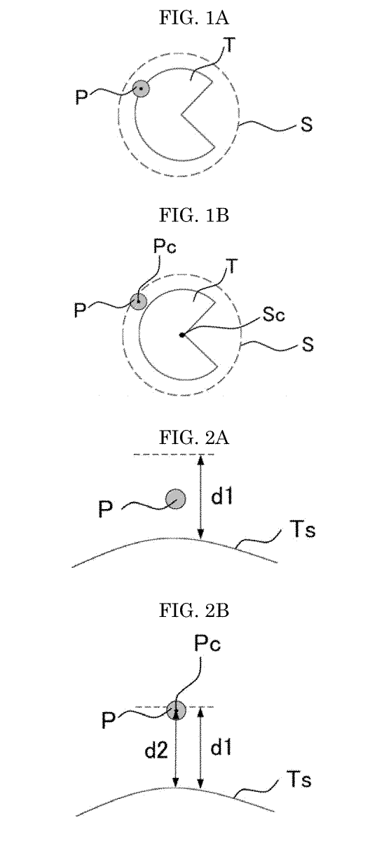

Examples of the case where the above-mentioned (1) is satisfied include a case illustrated in FIG. 1A. The case illustrated in FIG. 1A is a case where an entire probe molecule P is present inside a sphere S which is depicted with a broken line encapsulating the target molecule T.

Moreover, the case where the above-mentioned (1) is satisfied may be, for example, a case illustrated in FIG. 1B. The case illustrated in FIG. 1B is a case where a distance between a center Sc of a sphere S, which is depicted with a broken line encapsulating the target molecule T, and a center Pc of a probe molecule P is smaller than a radius of the sphere S. In this case, part of the probe molecule P may be positioned outside the sphere S as illustrated in FIG. 1B.

Examples of the case where the above-mentioned (2) is satisfied include a case illustrated in FIG. 2A. The case illustrated in FIG. 2A is a case where an entire probe molecule P is present within the predetermined distance d1 from a surface Ts of the target molecule T.

Moreover, the case where the above-mentioned (2) is satisfied may be, for example, a case illustrated in FIG. 2B. The case illustrated in FIG. 2B is a case where a distance between the surface Ts of the target molecule and the center Pc of the probe molecule P is smaller than the predetermined distance d1 from the surface Ts of the target molecule. In this case, a distance between part of the probe molecule P and the surface Ts of the target molecule may be greater than the predetermined distance d1 as illustrated in FIG. 2B.

Examples of the distance d1 include 3 Å.

Examples of the case where the above-mentioned (3) is satisfied include a case where a root mean square fluctuation (RMSF) of atoms of a probe molecule is determined, and the arithmetic mean value of RMSF of all of the atoms on which RMSF was determined is within the predetermined range. Examples of the range include 3 Å.

Hydrogen atoms may be excluded from atoms on which RMSF is determined. Atoms excluding the hydrogen atoms may be referred to as heavy atoms.

### <Second Calculation Step>

The second calculation step is a step including performing a molecular dynamic calculation in the presence of water molecules, where the molecular dynamic calculation is performed using the target molecule, the selected probe molecule, and other probe molecules, in the state that no unnatural repulsive force is added between the selected probe molecule and the above-mentioned other probe molecules.

In the second calculation step, a molecular dynamic calculation is performed in the state that no unnatural repulsive force is added between the selected probe molecule and the above-mentioned other probe molecules. A resulting state is that the above-mentioned other probe molecules can present within the binding site of the target molecule in addition to the selected probe molecule.

In the case where there are a plurality of probe molecules selected through selection steps performed earlier, no unnatural repulsive force is added between each of all the selected probe molecules and the above-mentioned other probe molecules in the second calculation step. Moreover, no unnatural repulsive force is added between the selected probe molecules.

The above-mentioned other probe molecules in the second calculation step may be an identical kind or different kind of probe molecules to the probe molecules used in the first calculation step. Moreover, the above-mentioned other probe molecules may be one kind of probe molecules or two or more kinds of probe molecules.

### <Second Selection Step>

The second selection step is a step including selecting the probe molecule stably bound with the target molecule (may be referred to as a “second selection probe molecule” hereinafter) among the above-mentioned other probe molecules using a result of the molecular dynamic calculation of the second calculation step.

The probe molecule stably bound with the target molecule means, in other words, the probe molecule having strong interaction with the target molecule. Such a probe molecule is highly likely present within a binding site of the target molecule.

In the second selection step, the presence or absence of the stable binding is preferably determined based on a distance from a sphere set based on the target molecule, a distance from a surface of the target molecule, and fluctuations of the probe molecule.

Examples of the sphere include a sphere encapsulating the target molecule. A size of the sphere is not particularly limited and may be appropriately selected depending on the intended purpose.

For example, it is preferred that a probe molecule be judged as to be stably bound with the target molecule when all of the (1) to (3), which have been described in association with the first selection step, are satisfied.

### <Determination Step>

The determination step is a step including determining a binding site of the target molecule using the selected probe molecules through the selection steps performed two or more times after performing the second calculation step and the second selection step once or two or more times.

In the determination step, for example, a binding site of the target molecule is determined from steric configurations of the probe molecules selected through the selection steps.

The first selection probe molecule is extracted by performing the first selection step. Moreover, one or two or more second selection probe molecules are extracted by performing the second selection step once or two or more times. As a result, a plurality of probe molecules present within a binding site of the target molecule can be extracted. Then, a binding site of the target molecule can be determined, for example, by observing steric configurations of the extracted probe molecules. In the case where the extracted probe molecules are regarded as one molecule, for example, a surface of the target molecule adjacent to such a molecule can be determined as a binding site.

In the case where each of the second calculation step and the second selection step is performed two or more times, the above-mentioned other probe molecules used in the second calculation step performed second time or later may be an identical or different kind of probe molecules to the probe molecules selected in the selection step performed earlier. Moreover, the above-mentioned other probe molecules may be one kind of probe molecules or two or more kinds of probe molecules.

Next, one example of the disclosed method for searching a binding site of a target molecule will be described with reference to a flowchart.

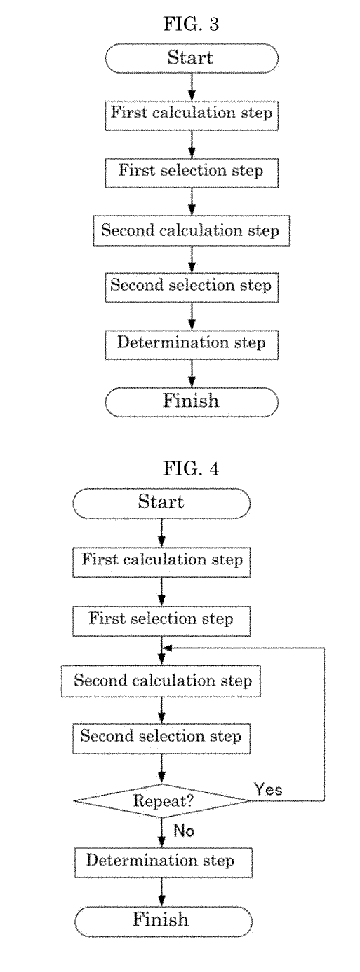

FIG. 3 is a flowchart describing one example of the method for searching a binding site of a target molecule. In this example, a second calculation step and a second selection step are each performed once. Note that, the time of the second calculation steps and the second selection steps to be performed may be determined as two or more times, in advance.

### [First Calculation Step]

First, a first calculation step is performed. In the first calculation step, a molecular dynamic calculation is performed in the presence of water molecules, where the molecular dynamic calculation is performed using a target molecule and a plurality of probe molecules arranged around the target molecule in a coordinate space, in the state that unnatural repulsive force is added between the probe molecules.

Specifically, first of all, a plurality of probe molecules and a plurality of water molecules are arranged around a target molecule in a coordinate space

Next, unnatural repulsive force is added between the probe molecules. The addition of the unnatural repulsive force can be performed by setting force generated between atoms when the molecular dynamic calculation is performed.

Note that, interactions, which are typically generated, are also added between the probe molecules. Moreover, interactions typically generated between the target molecule, the water molecules, and the probe molecules are also added to calculation conditions.

Then, a molecular dynamic calculation is performed. The duration of the molecular dynamic calculation is appropriately set.

### [First Selection Step]

Next, a first selection step is performed. In the first selection step, the probe molecule stably bound with the target molecule is selected from the probe molecules using the result of the molecular dynamic calculation of the first calculation step.

Specifically, the presence or absence of the stable binding is judged, for example, based on a distance from a sphere set based on the target molecule, a distance from a surface of the target molecule, and fluctuations of the probe molecule to select probe molecules stably bound with the target molecule.

### [Second Calculation Step]

Next, a second calculation step is performed. In the second calculation step, a molecular dynamic calculation is performed in the presence of water molecules, using the target molecule, the selected probe molecule and other probe molecules, in the state that no unnatural repulsive force is added between the selected probe molecule and the above-mentioned other probe molecules.

For example, calculation conditions of the molecular dynamic calculation are identical to the calculation conditions of the molecular dynamic calculation of the first calculation step.

### [Second Selection Step]

Next, a second selection step is performed. In the second selection step, the probe molecule stably bound with the target molecule is selected from the above-mentioned other probe molecules using the result of the molecular dynamic calculation of the second calculation step.

For example, the selection method is identical to the selection method of the first selection step.

### [Determination Step]

Next, a determination step is performed. In the determination step, a binding site of the target molecule is determined using the two probe molecules selected through the two selection steps performed.

Specifically, for example, a binding site of the target molecule is determined from steric configurations of the two selected probe molecules.

As described above, a binding site of the target molecule is searched.

Subsequently, another example of the disclosed method for searching a binding site of a target molecule will be described with reference to a flowchart.

FIG. 4 is a flowchart describing another example of the method for searching a binding site of a target molecule. In this example, whether a second calculation step and a second selection step are performed again or not is determined after a second selection step.

### [First Calculation Step]

First, a first calculation step is performed. In the first calculation step, a molecular dynamic calculation is performed in the presence of water molecules, where the molecular dynamic calculation is performed using a target molecule and a plurality of probe molecules arranged around the target molecule in a coordinate space, in the state that unnatural repulsive force is added between the probe molecules.

### [First Selection Step]

Next, a first selection step is performed. In the first selection step, a probe molecule stably bound with the target molecule is selected from the probe molecules using the result of the molecular dynamic calculation of the first calculation step.

### [Second Calculation Step]

Next, a second calculation step is performed. In the second calculation step, the molecular dynamic calculation is performed in the presence of water molecules, using the target molecule, the selected probe molecule and other probe molecules, in the state that no unnatural repulsive force is added between the selected probe molecule and the above-mentioned other probe molecules.

### [Second Selection Step]

Next, a second selection step is performed. In the second selection step, the probe molecule stably bound with the target molecule is selected from the above-mentioned other probe molecules using the result of the molecular dynamic calculation of the second calculation step.

Next, whether a second calculation step and a second selection step are performed again or not is judged. A method for judging is not particularly limited and may be appropriately selected depending on the intended purpose. For example, the judgement is performed considering a size and kind of the target molecule, and sizes and kinds of the probe molecules.

In the case where it is judged to perform a second calculation step and a second selection step again, a second calculation step and a second selection step are performed again. Then, whether a second calculation step and a second selection step are performed again or not is further judged. In the case where a second calculation step and a second selection step are performed again, a molecular dynamic calculation is performed, in the second calculation step, in the state that no unnatural repulsive force is added between the probe molecules selected so far and other probe molecules. Moreover, no unnatural repulsive force is added between the selected probe molecules.

In the case where it is judged not to perform a second calculation step and a second selection step again, the process proceeds to the following determination step.

### [Determination Step]

Next, a determination step is performed. In the determination step, a binding site of the target molecule is determined using the probe molecules selected through the selection steps performed.

Specifically, a binding site of the target molecule is determined, for example, from steric configurations of the probe molecules selected.

As described above, a binding site of the target molecule is searched.

Subsequently, another example of the disclosed method for searching a binding site of a target molecule will be described with reference to a flowchart.

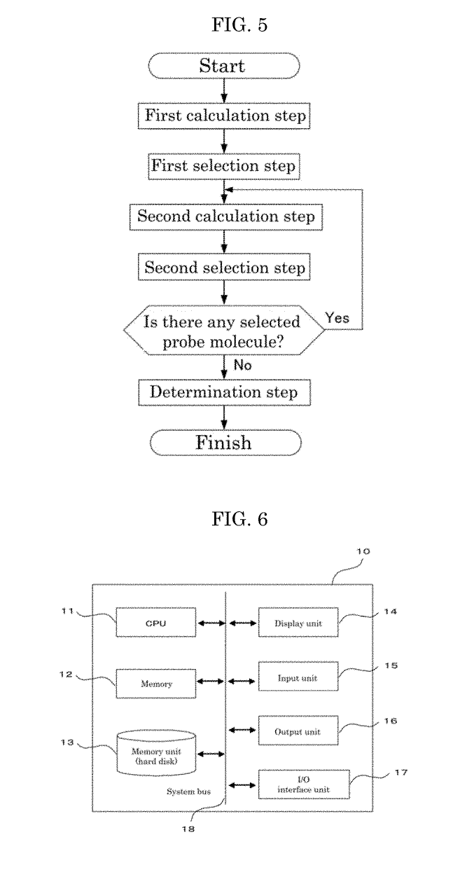

FIG. 5 is a flowchart describing another example of the method for searching a binding site of a target molecule. In this example, whether a second calculation step and a second selection step are performed again or not is determined based on, as a criterion for the judgement, the presence of the selected probe molecule in the second selection step.

### [First Calculation Step]

First, a first calculation step is performed. In the first calculation step, a molecular dynamic calculation is performed in the presence of water molecules, where the molecular dynamic calculation is performed using a target molecule and a plurality of probe molecules arranged around the target molecule in a coordinate space, in the state that unnatural repulsive force is added between the probe molecules.

### [First Selection Step]

Next, a first selection step is performed. In the first selection step, the probe molecule stably bound with the target molecule is selected from the probe molecules using the result of the molecular dynamic calculation of the first calculation step.

### [Second Calculation Step]

Next, a second calculation step is performed. In the second calculation step, a molecular dynamic calculation is performed in the presence of water molecules, using the target molecule, the selected probe molecule and other probe molecules, in the state that no unnatural repulsive force is added between the selected probe molecule and the above-mentioned other probe molecules.

### [Second Selection Step]

Next, a second selection step is performed. In the second selection step, the probe molecule stably bound with the target molecule is selected from the above-mentioned other probe molecules using the result of the molecular dynamic calculation of the second calculation step.

Next, a second calculation step and a second selection step are performed again, when there is the probe molecule selected in the second selection step.

In the case where a second calculation step and a second selection step are performed again, a molecular dynamic calculation is performed, in the second calculation step, in the state that no unnatural repulsive force is added between the probe molecules selected so far and other probe molecules. Moreover, no unnatural repulsive force is added between the selected probe molecules.

In the case where there is no probe molecule selected in the second selection step, on the other hand, the process proceeds to the following determination step.

### [Determination Step]

Next, a determination step is performed. In the determination step, the binding site of the target molecule is determined using the probe molecules selected through the selection steps performed.

Specifically, a binding site of the target molecule is determined, for example, from steric configurations of the probe molecules selected.

As described above, a binding site of the target molecule is searched.

### (Program)

The disclosed program for searching a binding site of a target molecule is a program for causing a computer to execute the disclosed method for searching a binding site of a target molecule.

In the program for searching a binding site of a target molecule, a preferable embodiment for executing the method for searching a binding site of a target molecule is identical to the preferable embodiment in the disclosed method for searching a binding site of a target molecule.

The program can be created using any of various programing languages known in the art according to a configuration of a computer system for use, a type or version of an operation system for use.

The program may be recorded on a non-transitory recording medium, such as an integral hard disk, and an external hard disk, or recorded on a non-transitory recording medium, such as a compact disc read only memory (CD-ROM), a digital versatile disk read only memory (DVD-ROM), a magneto-optical (MO) disk, and a universal serial bus (USB) memory stick (USB flash drive). In the case where the program is recorded on a non-transitory recording medium, such as a CD-ROM, a DVD-ROM, an MO disk, and an USB memory stick, the program can be used, as required, directly or by installing a hard disk via a non-transitory recording medium reader equipped in a computer system. Moreover, the program may be recorded in an external memory region (e.g. another computer) accessible from the computer system via an information and communication network, and the program may be used, as required, by directly from the external memory region or installing into a hard disk from the external memory region via the information and communication network.

The program may be divided into predetermined processes and recorded on a plurality of non-transitory recording mediums.

### (Computer-Readable Non-Transitory Recording Medium)

The disclosed computer-readable non-transitory recording medium includes the disclosed program stored thereon.

The computer-readable non-transitory recording medium is not particularly limited and may be appropriately selected depending on the intended purpose. Examples of the computer-readable non-transitory recording medium include integral hard disks, external hard disks, CD-ROMs, DVD-ROMs, MO disks, and USB memory sticks.

The non-transitory recording medium may be a plurality of non-transitory recording mediums to which the program is divided into predetermined processes and recorded.

### (Device for Searching Binding Site of Target Molecule)

The disclosed device for searching a binding site of a target molecule includes at least a first calculation unit, a first selection unit, a second calculation unit, a second selection unit, and a determination unit. The device may further include other units according to the necessity.

The first calculation unit is configured to perform a molecular dynamic calculation in the presence of water molecules, where the molecular dynamic calculation is performed using a target molecule and a plurality of probe molecules arranged around the target molecule in a coordinate space, in the state that no unnatural repulsive force is added between the probe molecules. Specifically, the first calculation unit is configured to execute the first calculation step.

The first selection unit is configured to select the probe molecule stably bound with the target molecule among the probe molecules using the result of the molecular dynamic calculation of the first calculation step. Specifically, the first selection unit is configured to execute the first selection step.

The second calculation unit is configured to perform a molecular dynamic calculation in the presence of water molecules, where the molecular dynamic calculation is performed using the target molecule, the selected probe molecule, and other probe molecules, in the state that no unnatural repulsive force is added between the selected probe molecule and the above-mentioned other probe molecules. Specifically, the second calculation unit is configured to execute the second calculation step.

The second selection unit is configured to select the probe molecule stably bound with the target molecule from the above-mentioned other probe molecules using the result of the molecular dynamic calculation of the second calculation step. Specifically, the second selection unit is configured to execute the second selection step.

The determination unit is configured to determine a binding site of the target molecule using the selected probe molecules through the selection steps performed two or more times after performing the second calculation step and the second selection step once or two or more times. Specifically, the determination unit is configured to execute the determination step.

A preferable embodiment of a processing method of each unit of the device for searching a binding site of a target molecule is identical to the preferable embodiment of each step of the method for searching a binding site of a target molecule.

The device for searching a binding site of a target molecule may be a plurality of devices for searching a binding site of a target molecule, where each device includes recording media to which the program that is divided into predetermined processes and recorded.

A structural example of the disclosed device for searching a binding site of a target molecule is illustrated in FIG. 6.

For example, the device for searching a binding site of a target molecule 10 is assembled by connecting CPU 11, a memory 12, a memory unit 13, a display unit 14, an input unit 15, an output unit 16, and an I/O interface unit 17 via a system bus 18.

The central processing unit (CPU) 11 is configured to perform calculation (e.g., four arithmetic operation and relational operation), and control of operations of hardware and software.

The memory 12 is a memory, such as a random access memory (RAM), and a read only memory (ROM). The RAM is configured to store an operation system (OS) and application programs read from the ROM and the memory unit 13, and function as a main memory and work area of the CPU 11.

The memory unit 13 is a device for storing various programs and data. For example, the memory unit 13 is a hard disk. In the memory unit 13, programs to be executed by the CPU 11, data required for executing the programs, and an OS are stored.

The program is stored in the memory unit 13, loaded on the RAM (a main memory) of the memory 12, and executed by the CPU 11.

The display unit 14 is a display device. For example, the display unit is a display device, such as a CRT monitor, and a liquid crystal panel.

The input unit 15 is an input device for various types of data. Examples of the input unit include a key board, and a pointing device (e.g., a mouse).

The output unit 16 is an output device for various types of data. For example, the output unit is a printer.

The I/O interface unit 17 is an interface for connecting to various external devices. For example, the I/O interface unit enables input and output of data of CD-ROMs, DVD-ROMs, MO disks, and USB memory sticks.

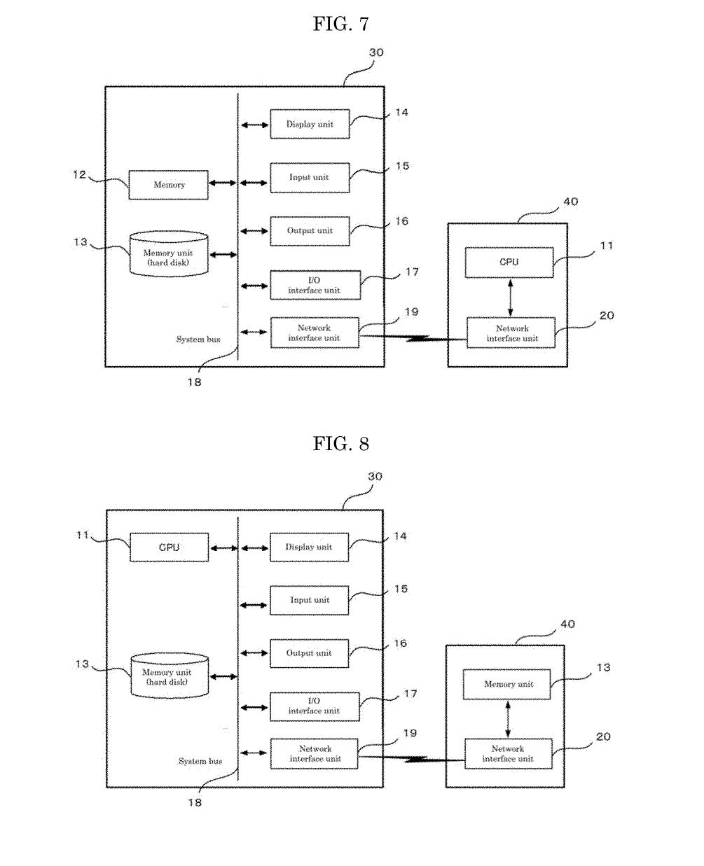

Another structural example of the disclosed device for searching a binding site of a target molecule is illustrated in FIG. 7.

The structural example of FIG. 7 is a structural example of a cloud-type device, where CPU 11 is independent from a memory unit 13 etc. In the structural example, a computer 30 storing therein the memory unit 13 etc. and a computer 40 storing therein the CPU 11 are coupled with each other via network interface units 19 and 20.

The network interface units 19 and 20 are hardware configured to communicate using the internet.

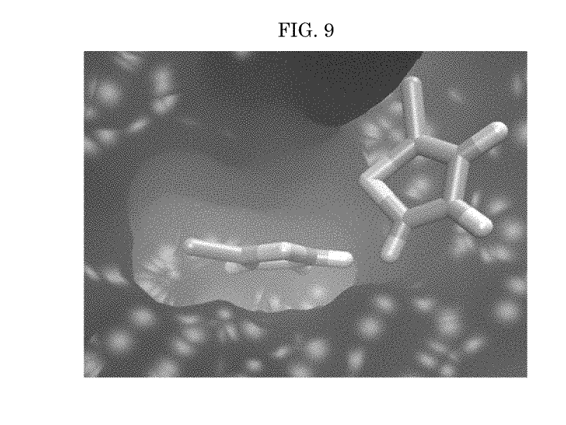

Another structural example of the disclosed device for searching a binding site of a target molecule is illustrated in FIG. 8.

The structural example of FIG. 8 is a structural example of a cloud-type device, where a memory unit 13 is independent of CPU 11, etc. In the structural example, a computer 30 storing CPU 11 etc. and a computer storing the memory unit 13 are connected via network interface units 19 and 20.

### EXAMPLES

The disclosed technology will be described hereinafter, but Examples below shall not be construed as to limit the scope of the disclosed technology.

### Example 1

The disclosed method for searching a binding site of a target molecule was performed according to the flow illustrated in FIG. 3. Specifically, the method was performed in the following manner.

As a target molecule, a blood coagulation factor Xa(fXa) that was a protein was used.

As probe molecules, thiophene chloride was used.

Note that, a co-crystal structure of the blood coagulation factor Xa (fXa) and known ligand RRR has been known [PDB:1NFW].

### <First Calculation Step>

In a coordinate space, 1,303 probe molecules and 9,596 water molecules were randomly arranged at the periphery of the target molecule.

As repulsive potential, a function, which exponentially reduced as a distance increased, was set between the probe molecules.

Subsequently, a molecular dynamic calculation was performed using GROMACS. Specifically, a temperature of the target molecule was set to 25° C. and a temperature of the probe molecules was set to 125° C. in the NTV ensemble. Regarding the target molecule, heavy atoms of a principle chain of the target molecule were restrained to an approximate size of heat fluctuations. The simulation time was set to 800 ps.

### <First Selection Step>

As conditions for determining the presence or absence of stable binding, the following (1-1) to (1-3) were set.
(1-1) A probe molecule is present inside a sphere (radius: 20 Å) encapsulating the target molecule.
(1-2) The probe molecule is present within a certain distance (3 Å) from a surface of the target molecule.
(1-3) Fluctuations (RMSF) of the probe molecule are within 4 Å.

After superimposing a structure included in the trajectory of the molecular dynamic calculation with the heavy atoms of the principle chain of the target molecule, the probe molecules satisfying the above-mentioned (1-1) were extracted. From the extracted probe molecules, moreover, the probe molecules satisfying the above-mentioned (1-2) were extracted. From the extracted probe molecules, furthermore, the probe molecule satisfying the above-mentioned (1-3) was extracted. In this manner, the probe molecule satisfying all of the (1-1) to (1-3) was selected. The number of the selected probe molecule(s) was 1.

### <Second Calculation Step>

A molecular dynamic calculation was further performed for 800 ps in the same manner as in the first calculation step, except that repulsive potential was not added between the selected probe molecule and the other probe molecules.

### <Second Selection Step>

The probe satisfying all of the above-mentioned (1-1) to (1-3) was selected in the same manner as in the first selection step. As a result, other than the probe molecule selected in the first selection step, one probe molecule was selected.

As a result, as depicted in FIG. 9, a structure where the two probe molecules were bound within a binding site of the target molecule (protein fXa) with a distance within 3 Å or less was obtained, where the binding site is a binding site with which a known inhibitor RRR could be bound.

According to a known method where repulsive potential is added between probe molecules, it is difficult to appropriately obtain a binding structure of two probe molecules bound within the same site due to repulsive potential present between the probe molecules. According to the disclosed method, however, such an appropriate structure could be obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the sprit and scope of the invention.

What is claimed is:

1. A method for searching a binding site of a target molecule, the method causing a computer to execute steps comprising:
a first calculation step including performing a molecular dynamic calculation in the presence of water molecules, where the molecular dynamic calculation is performed using a target molecule and a plurality of probe molecules arranged around the target molecule in a coordinate space, in the state that unnatural repulsive force is added between the probe molecules;
a first selection step including selecting the probe molecule stably bound with the target molecule among the probe molecules using a result of the molecular dynamic calculation of the first calculation step;
a second calculation step including performing a molecular dynamic calculation in the presence of water molecules, where the molecular dynamic calculation is performed using the target molecule, the selected probe molecule, and other probe molecules, in the state that no unnatural repulsive force is added between the selected probe molecule and the other probe molecules;
a second selection step including selecting the probe molecule stably bound with the target molecule among the other probe molecules using a result of the molecular dynamic calculation of the second calculation step; and
a determination step including determining a binding site of the target molecule using the probe molecules selected through the selection steps performed two or more times after performing the second calculation step and the second selection step once or two or more times.

2. The method according to claim 1,
wherein each of the first selection step and the second selection step includes judging the presence or absence of the stable binding based on a distance from a sphere set based on the target molecule, a distance from a surface of the target molecule, and fluctuations of the probe molecules.

3. The method according to claim 1,
wherein the unnatural repulsive force is repulsive force that increases as a distance between probe molecules decreases.

4. The method according to claim 1,
wherein the binding site of the target molecule is determined in the determination step based on steric configurations of the probe molecules selected through the selection steps performed two or more times.

5. A device for searching a binding site of a target molecule, the device comprising:
a first calculation unit configured to execute a first calculation step, where the first calculation step includes performing a molecular dynamic calculation in the presence of water molecules, where the molecular dynamic calculation is performed using a target molecule and a plurality of probe molecules arranged around the target molecule in a coordinate space, in the state that unnatural repulsive force is added between the probe molecules;
a first selection unit configured to execute a first selection step, where the first selection step includes selecting the probe molecule stably bound with the target molecule among the probe molecules using a result of the molecular dynamic calculation of the first calculation step;
a second calculation unit configured to execute a second calculation step, where the second calculation step includes performing a molecular dynamic calculation in the presence of water molecules, where the molecular dynamic calculation is performed using the target molecule, the selected probe molecule, and other probe molecules, in the state that no unnatural repulsive force is added between the selected probe molecule and the other probe molecules;
a second selection unit configured to execute a second selection step, where the second selection step includes selecting the probe molecule stably bound with the target molecule among the other probe molecules using a result of the molecular dynamic calculation of the second calculation step; and
a determination unit configured to execute a determination step where the determination step includes determining a binding site of the target molecule using the probe molecules selected through the selection steps performed two or more times after performing the second calculation step and the second selection step once or two or more times.

6. The device according to claim 5,
wherein each of the first selection unit and the second selection unit is configured to judge the presence or absence of the stable binding based on a distance from a sphere set based on the target molecule, a distance from a surface of the target molecule, and fluctuations of the probe molecules.

7. The device according to claim 5,
wherein the unnatural repulsive force is repulsive force that increases as a distance between probe molecules decreases.

8. The device according to claim 5,
wherein the determination unit is configured to determine a binding site of the target molecule based on steric configurations of the probe molecules selected through the selection steps performed two or more times.
